(19) United States
(12) Patent Application Publication
(10) Pub. No.: US 2010/0154308 A1
(43) Pub. Date: Jun. 24, 2010

(54) SLIDING DOOR CHUCKING AND STRENGTHENING DEVICE

(76) Inventors: Venky Krishnan, Canton, MI (US); Kosta Papanikolaou, Hunlington Woods, MI (US); Bhupendra A Patel, Canton, CT (US); Jerry P Bonnici, Macomb, MI (US)

Correspondence Address: PRICE, HENEVELD, COOPER, DEWITT & LITTON, LLP;FGTL, 695 KENMOOR S.E., P. O. BOX 2567, GRAND RAPIDS, MI, 49501-2567, US

(21) Appl. No.: 12/338,558

(22) Filed: Dec. 18, 2008

(51) Int. Cl. E05F 11/02; E06B 3/00

(52) U.S. Cl. 49/327; 49/339; 49/506

(57) ABSTRACT

A door chucking system includes a slidable door movable within a door opening and having a distal edge, the door being operable between opened and closed positions. A vertical column is proximate the distal edge of the door when the door is in the closed position. A chucking wedge is disposed on one of the vertical column and the distal edge, the chucking wedge including a retaining slot and a retaining flange. A receiver is disposed on the other of the vertical column and the distal edge, the receiver including a rigid tab, wherein the receiver receives a portion of the chucking wedge therein when the door is in the closed position, and wherein application of a force that is at least partially transverse to the planar extent of the door causes the rigid tab and the retaining slot to engage thereby preventing the door from leaving the closed position.

### FIELD OF THE INVENTION

The present invention generally relates to a door chucking device, and more specifically to a door chucking device that strengthens the door connection to an adjacent column during accidental impact.

### BACKGROUND OF THE PRESENT INVENTION

Strengthening devices are used in vehicles to prevent accidental opening of vehicle doors during a collision.

### SUMMARY OF THE INVENTION

In one aspect of the present invention, a door chucking system includes a laterally slidable door movable within a door opening and having a distal edge, the door being operable between opened and closed positions. A vertical column is proximate the distal edge of the door when the door is in the closed position. A chucking wedge is disposed on one of the vertical column and the distal edge, the chucking wedge including a retaining slot and a retaining flange. A receiver is disposed on the other of the vertical column and the distal edge, the receiver including a rigid tab, wherein the receiver receives a portion of the chucking wedge therein when the door is in the closed position, and wherein application of a force that is at least partially transverse to the planar extent of the door causes the rigid tab and the retaining slot to engage thereby preventing the door from leaving the closed position.

In another aspect of the present invention, a door chucking system includes a laterally slidable door movable within a door opening and having a distal edge, the door being operable between open and closed positions. A vertical column is proximate the distal edge of the door when the door is in the closed position. An elongate engagement member is disposed on one of the vertical column and the distal edge, the engagement member including a distal retaining head. A receiver is disposed on the other of the vertical column and the distal edge, the receiver including a head receiving aperture, wherein the receiver receives the distal retaining head therein when the door is in the closed position and wherein application of force that is at least partially transverse to the planar extent of the door causes the distal retaining head to be captured in the head receiving aperture thereby preventing the door from entering the open position.

Yet another aspect of the present invention includes a method of securing a door in a door opening of the vehicle. A vehicle door having an inboard side, an outboard side, and a distal edge, is provided and is movable between open and closed positions. A vertical column is formed that is proximate the distal edge of the vehicle door when the vehicle door is in the closed position. A receiving member is provided on the other of the distal edge of the vehicle door and the vertical column. An engagement member extends from one of the distal edge of the vehicle door and the vertical column, and the engagement member includes a securing portion. An outward force is applied to the inboard side of the vehicle door and the securing portion of the engagement member is engaged with the receiving member.

These and other features, advantages, and objects of the present invention will be further understood and appreciated by those skilled in the art upon studying the following specification, claims, and appended drawings.

### BRIEF DESCRIPTION OF THE DRAWINGS

FIG. 1 is partial top perspective view of one embodiment of a door chucking and strengthening system with a door open;

FIG. 2 is the system of FIG. 1, with the door closed;

FIG. 3 is a side elevational view of a receiver of the door chucking and strengthening system;

FIG. 4 is a top elevational view of the receiver of FIG. 3;

FIG. 5 is a top elevational cross-sectional view of the receiver of FIG. 4 taken at line V-V;

FIG. 6 is a top perspective view of a chucking wedge of the door chucking and strengthening system;

FIG. 7 is a first side elevational view of the chucking wedge;

FIG. 8 is a second side elevational view of the chucking wedge;

FIG. 9 is a top cross-sectional view of the receiver receiving the chucking wedge prior to impact;

FIG. 10 is a top elevational cross-sectional view of the receiver and chucking wedge after a collision;

FIG. 11 is a top perspective view of another embodiment of a door chucking and strengthening system with the door open;

FIG. 12 is a top perspective view of the door chucking and strengthening system of FIG. 11 with the door closed;

FIG. 13 is a first side elevational view of an elongate engagement member;

FIG. 14 is a second side elevational view of an elongate engagement member;

FIG. 15 is a side elevational view of another embodiment of a receiver;

FIG. 16 is a top elevational cross-sectional view of the elongate engagement member inserted into the receiver; and

FIG. 17 is a top elevational cross-sectional view of an elongate engagement member inserted into the receiver after a collision.

### DETAILED DESCRIPTION OF EMBODIMENTS

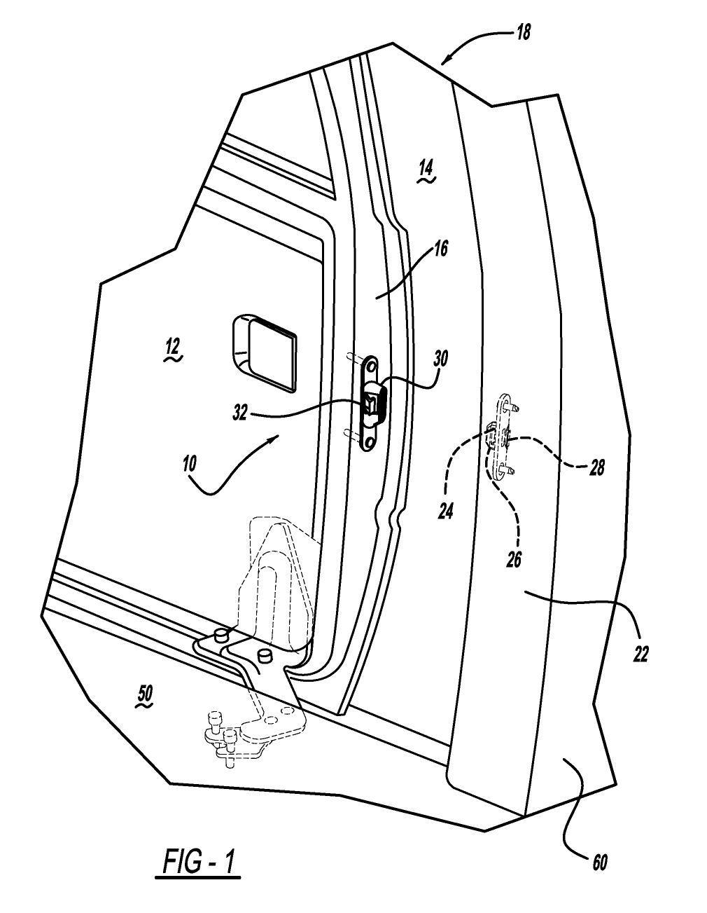

For purposes of description herein the terms “upper,” “lower,” “right,” “left,” “rear,” “front,” “vertical,” “horizontal” and derivatives thereof shall relate generally to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIG. 1, which illustrates the door chucking system as viewed from inside a vehicle, the reference numeral 10 generally designates a door chucking system having a laterally slidable door 12 movable within a door opening 14 and having a distal edge 16. The door 12 is operable between opened and closed positions 18, 20. A vertical column 22 is proximate the distal edge 16 of the door 12 when the door 12 is in the closed position 20. A chucking wedge 24 is disposed on one of the vertical column 22 and the distal edge 16. The chucking wedge 24 includes a retaining slot 26 and a retaining flange 28. A receiver 30 is disposed on the other of the vertical column 22 and the distal edge 16. The receiver 30 includes a rigid tab 32. The receiver 30 receives a portion 34 of the chucking wedge 24 therein when the door 12 is in the closed position 20. Application of a force that is at least partially transverse to the planar extent of the door 12 causes the rigid tab 32 and the retaining slot 26 to engage thereby preventing the door 12 from leaving the closed position 20.

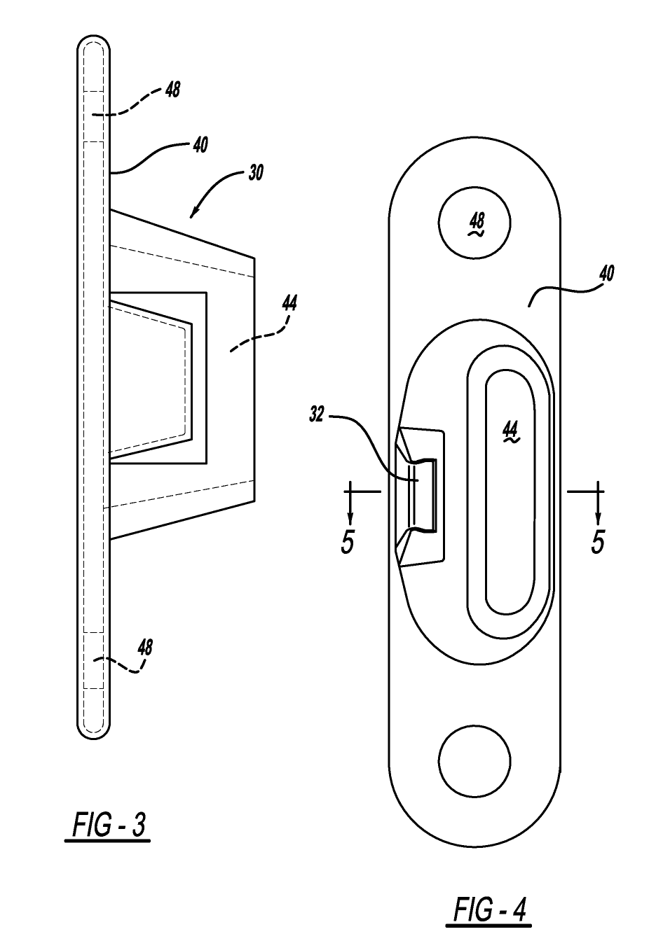

Referring now to FIGS. 3 and 4, the illustrated embodiment of the receiver 30 includes an elongate base plate 40 from which the receiver 30 extends. The receiver 30 includes an engagement wall 42 formed from a pliable material adapted to malform upon impact discussed in further detail below. The engagement wall 42 defines a receiving aperture 44. The rigid tab 32 is adjacent the pliable material of the engagement wall 42 and forms part of the receiver 30. The rigid tab 32 includes a distal engagement end 46 that is aligned with the exterior surface of the engagement wall 42. Additionally, the distal engagement end 46 is aligned with an external side 47 of the engagement wall 42, but does not extend into the receiving aperture 44. The elongate base plate 40 includes two mechanical fastener apertures 48 that connect the receiver 30 to the door 12 of a vehicle 50.

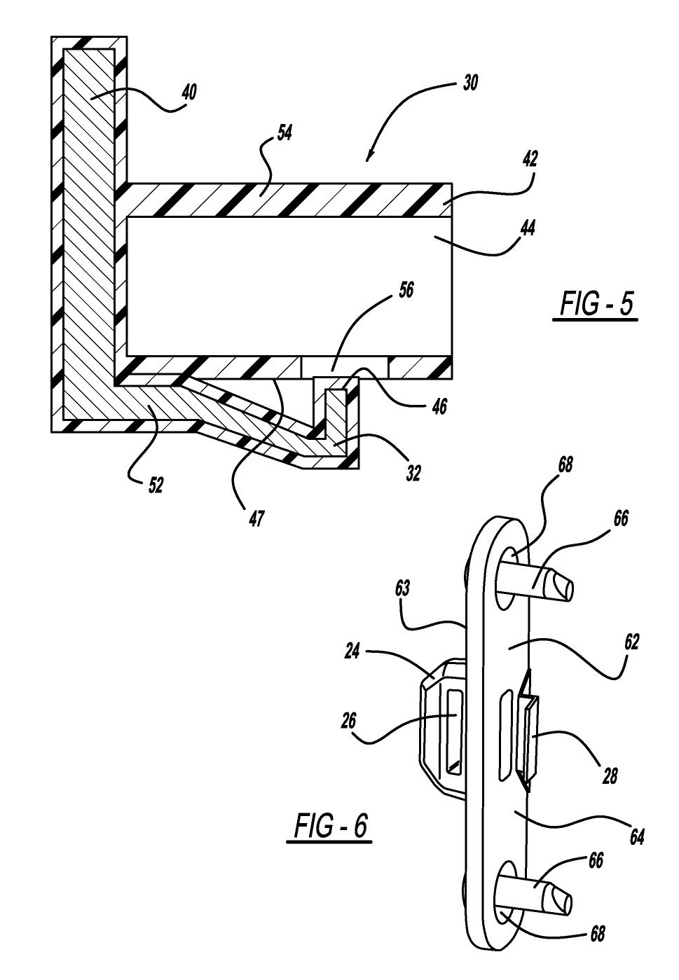

As shown in FIG. 5, the elongate base plate 40 of the receiver 30 includes a high strength material 52 (such as steel) covered by a low strength material 54 (such as rubber or plastic). The low strength material 54 is rigid enough to withstand normal chucking loads but will disintegrate or be crushed during crash loads. The high strength material 52 is integral with the rigid tab 32, and the rigid tab 32 extends from the elongate base plate 40. In addition, like the elongate base plate 40, the rigid tab 32 is covered by a pliable low strength material 54. The engagement wall 42 of the receiving aperture 44 includes only the low strength pliable material 54, and also includes a tab aperture 56 adjacent the distal engagement end 46 of the rigid tab 32. The function of the tab aperture 56 is explained in further detail below.

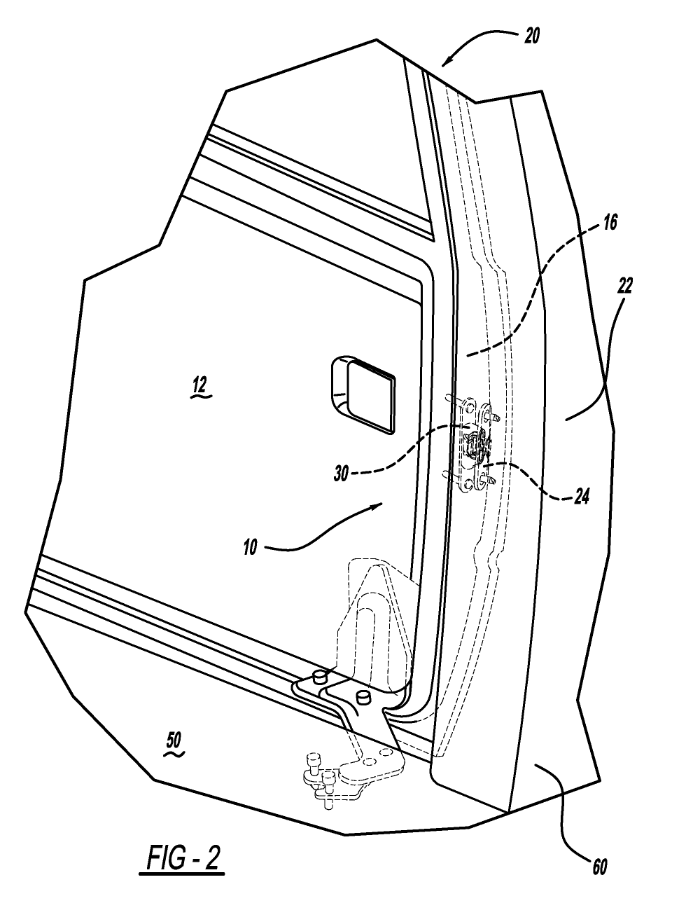

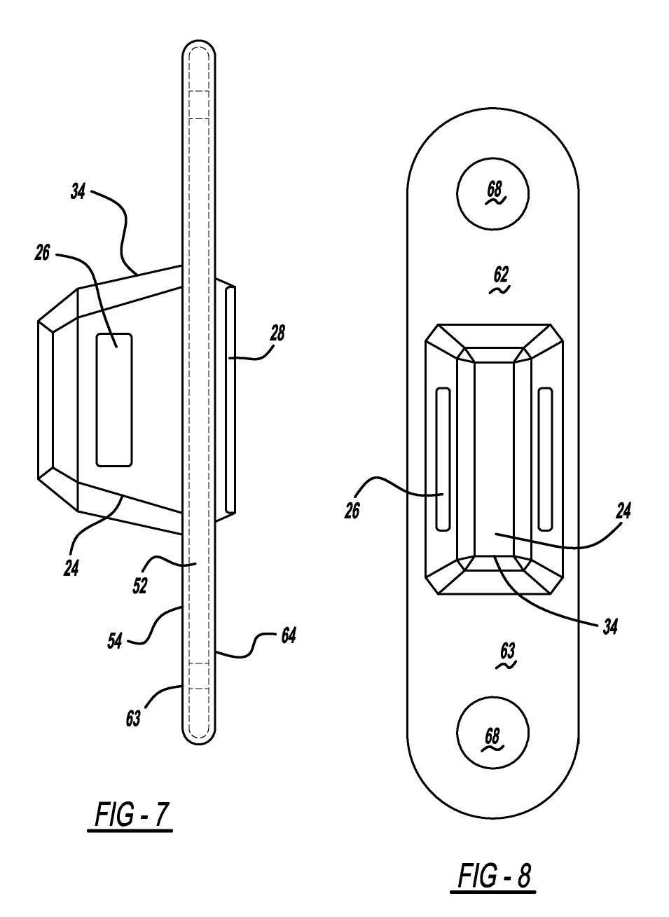

Referring now to FIGS. 6-8, the chucking wedge 24 is connected with the vertical column 22 of the vehicle frame 60 (FIGS. 1 and 2). A chucking wedge base plate 62 abuts the vertical column 22 and the chucking wedge 24 extends from a forward side 63 of the base plate 62 and the retaining flange 28 extends from a rear side 64 of chucking wedge base plate 62. The retaining flange 28 engages with the vertical column 22 and secures the chucking wedge 24 and base plate 62 to the vertical column 22. Additional support is provided by top and bottom chucking wedge fasteners 66. The chucking wedge 24 and base plate 62 are covered by the pliable low strength material 54 (such as plastic). The high strength material 52 (such as steel) is disposed below the pliable low strength material 54 and integrally connects the base plate 62 to the chucking wedge 24. The retaining slot 26 extends through the chucking wedge 24 and is designed for engagement with the rigid tab 32 of the receiver 30, as discussed in further detail below. Top and bottom mechanical fastener apertures 68 on the chucking wedge base plate 62 allow the chucking wedge base plate 62 to be secured to the vertical column 22. Although the illustrations depict the chucking wedge 24 being disposed on the vertical column 22 and the receiver 30 being disposed on the door 12, one having ordinary skill in the art will recognize that the chucking wedge 24 could be secured anywhere along the vertical column 22 or the distal edge 16 of the door 12. Similarly, the receiver 30 may be disposed anywhere along the distal edge 16 of the door 12 or on the vertical column 22.

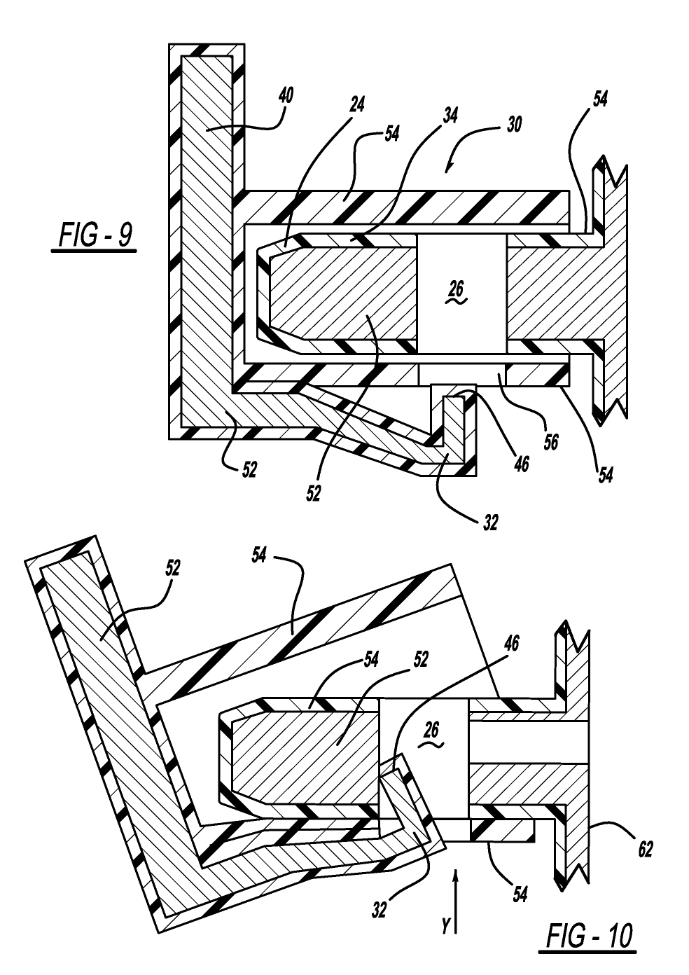

FIGS. 9 and 10, which illustrate the chucking wedge 24 is inserted into the receiver 30 also show engagement of the chucking wedge 24 and receiver 30 prior to a collision (FIG. 9) and after a collision or Federal Motor Vehicle Safety Standards push out loading test (FIG. 10). During typical use, when a vehicle user closes the door 12 of the vehicle 50, the receiver 30 engages and extends around the chucking wedge 24. Minimal contact if any is made between the pliable low strength material 54 of the chucking wedge 24 and the receiver 30. However, it is contemplated that the pliable low strength material 54 of the receiver 30 and chucking wedge 24 may be designed to snugly fit during closure of the vehicle door 12. When the door 12 is used in this fashion, the high strength material 52 of the chucking wedge 24 and the high strength material 52 of the receiver 30 do not engage.

Referring now to FIG. 10, during a collision, the chucking wedge 24 and receiver 30 become unaligned, such that the high strength material 52 of the chucking wedge 24 engages the high strength material 52 on the rigid tab 32 of the receiver 30. More specifically, as a result of a resultant force in the direction of arrow Y during a collision, the rigid tab 32 of the receiver 30 is forced into the retaining slot 26 of the chucking wedge 24. The pliable low strength material 54 of the receiver 30 is crushed, as is the pliable low strength material 54 of the chucking wedge 24, such that the high strength material 52 of the rigid tab 32 of the receiver 30 securely engages with the high strength material 52 in the retaining slot 26 of the chucking wedge 24. Accordingly, a force applied to the inside of the door 12 in the direction of arrow Y will not cause the door 12 to open.

When the vehicle 50 is traveling, loading caused by vehicle movement will cause the receiver 30 to contact the chucking wedge 24. The receiver 30 is designed to withstand these minimal loadings thereby preventing door chuck. Door chuck is generally defined as excessive outboard movement of the vehicle door 12 as a result of the vehicle 50 traveling on rough roads.

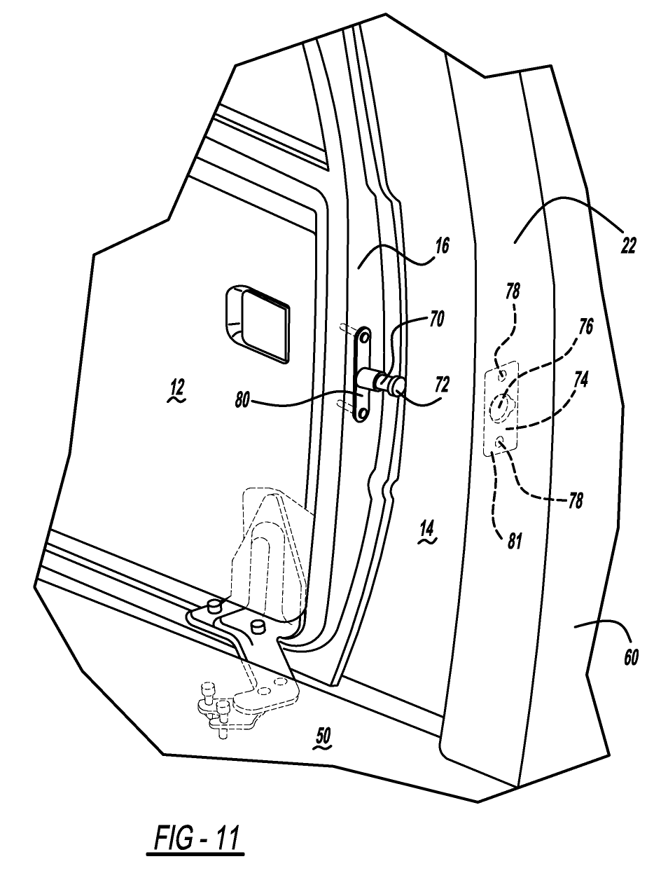

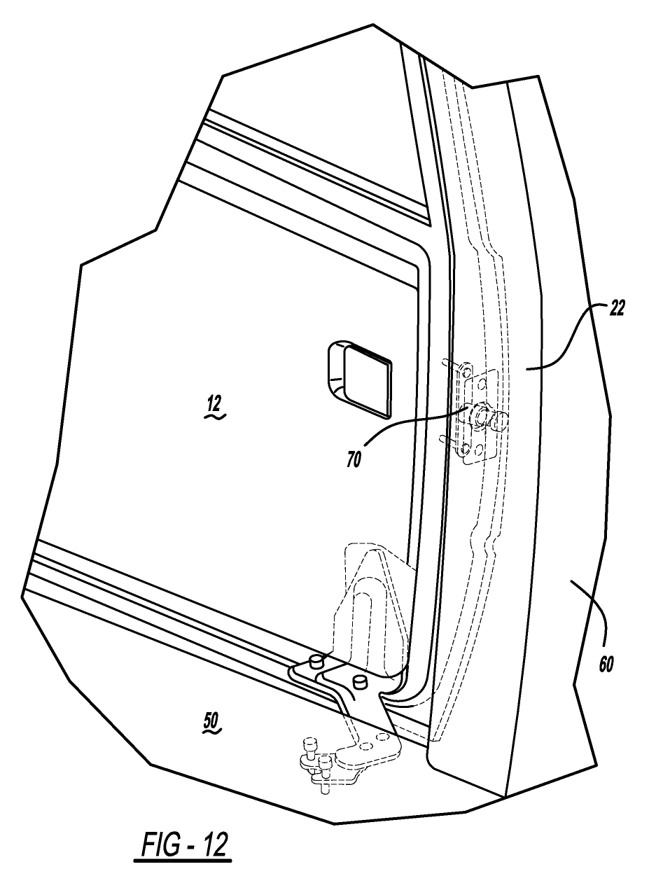

Another embodiment of the instant invention is illustrated in FIGS. 11 and 12. An elongate engagement member 70 extends from the laterally slidable door 12 in the direction of travel. The elongate engagement member 70 includes a distal retaining head 72. A receiver 74 is disposed opposite the elongate engagement member 70 and includes a head receiving aperture 76. The head receiving aperture 76 is designed to receive the distal retaining head 72 of the elongate engagement member 70. The elongate engagement member 70 includes an elongate engagement member base plate 80 and the receiver 74 includes a receiver base plate 81. Both the elongate engagement member base plate 80 and the receiver base plate 81 include fastener apertures 78 for receiving mechanical fasteners securely fastening the elongate engagement member 70 and the receiver 74 to the door 12 and vertical column 22, respectively. As with the previous embodiment, one having ordinary skill in the art will recognize that the elongate engagement member 70 could also be positioned on the vertical column 22 and the receiver 74 could be disposed on the distal edge 16 of the door 12. Referring again to FIG. 12, head receiving aperture 76 is adapted for receiving the elongate engagement member 70 and the distal retaining head 72 during closure of the door 12 during typical use. The distal retaining head 72 does not engage any portion of the receiver 70 or the head receiving aperture 76 during normal use.

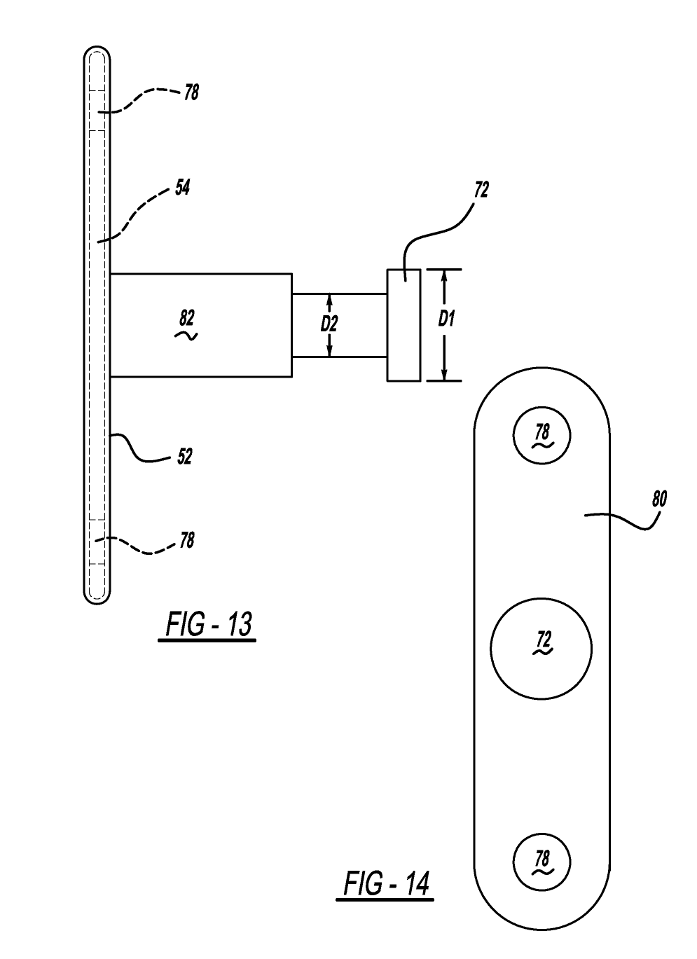

As shown in FIGS. 13 and 14, the elongate engagement member 70 includes an elongate engagement member base plate 80 that is covered by the low strength pliable material 54. The elongate engagement member 70 extends from the elongate engagement member base plate 80 and is partially covered by a pliable sleeve 82. The elongate engagement member 70 extends beyond the sleeve 82 and terminates at the distal retaining head 72. In addition, the distal retaining head 72 has a diameter D1 that is larger than the diameter D2 of a body portion 84 of the elongate engagement member 70.

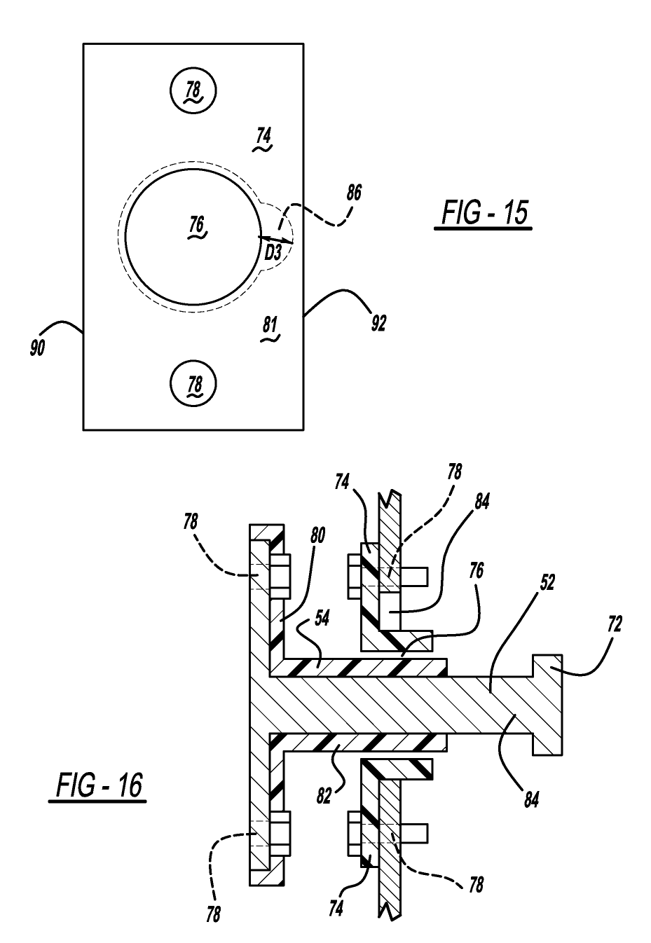

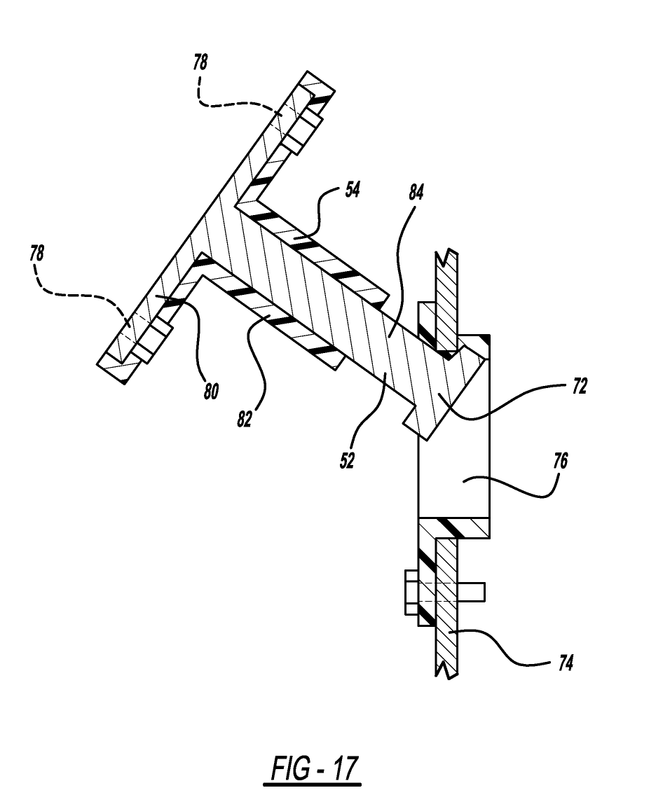

As shown in FIG. 15, the head receiving aperture 76 is covered in a low strength pliable material 54. The head receiving aperture 76 includes a head slot 86 having a diameter D3 that is larger than the diameter D2 of the body portion 84 of the elongate engagement member 70, but smaller than the diameter D1 of the distal retaining head 72. The low strength pliable material 54 extends over the head receiving aperture 76 covering the head slot 86 and the head receiving aperture 76. The head receiving aperture 76 generally includes an inboard side 90 and an outboard side 92 and the head slot 86 is adjacent on the outboard side 92 of the head receiving aperture 76. During normal use, as shown in FIG. 16, the elongate engagement member 70 will not contact the low strength pliable material 54 nor the high strength portion 52 of the elongate engagement member 70. However, during a collision, the elongate engagement member 70 is forced against the head slot 86. When the body portion 84 of the elongate engagement member 70 engages the head slot 86, the elongate engagement member 70 slides in the head receiving aperture 76 until the distal retaining head 72 abuts the head slot 86, which has a larger diameter D1 than the head slot diameter D3. Accordingly, the door 12 of the vehicle 50 is prevented from opening as a result of the distal retaining head 72 being captured by the head slot 86.

The above description is considered that of the illustrated embodiments only. Modifications of the invention will occur to those skilled in the art and to those who make or use the invention. Therefore, it is understood that the embodiments showing the drawings and described above are merely for illustrative purposes and not intended to limit the scope of the invention, which is defined by the following claims as interpreted according to the principles of patent law, including the Doctrine of Equivalents.

We claim:

1. A door chucking system, comprising:
a laterally slidable door movable within a door opening and having a distal edge, the door being operable between opened and closed positions;
a vertical column proximate the distal edge of the door when the door is in the closed position;
a chucking wedge disposed on one of the vertical column and the distal edge, the chucking wedge including a retaining slot and a retaining flange; and
a receiver disposed on the other of the vertical column and the distal edge, the receiver including a rigid tab, wherein the receiver receives a portion of the chucking wedge therein when the door is in the closed position, and wherein application of a force that is at least partially transverse to the planar extent of the door causes the rigid tab and the retaining slot to engage thereby preventing the door from leaving the closed position.

2. The door chucking system of claim 1, wherein:
the receiver includes a groove defined by an engagement wall, the engagement wall having an interior surface that substantially surrounds the chucking wedge when the door is in the closed position.

3. The door chucking system of claim 2, wherein:
the rigid tab includes a distal engagement end that is aligned with the interior surface of the engagement wall and which does not extend into the groove.

4. The door chucking system of claim 1, wherein:
the rigid tab is constructed from steel and the engagement wall is formed from a material adapted to malform upon impact.

5. The door chucking system of claim 1, wherein:
the chucking wedge is covered with a polymer material.

6. The door chucking system of claim 1, wherein:
the chucking wedge is integrally connected with a base plate.

7. The door chucking system of claim 6, further comprising:
a polymer material that extends over the base plate.

8. The door chucking system of claim 1, further comprising:
a retaining flange integrally connected with the retaining slot and fixedly attached to the vertical column.

9. A door chucking system, comprising:
a laterally slidable door movable within a door opening and having a distal edge, the door being operable between open and closed positions;
a vertical column proximate the distal edge of the door when the door is in the closed position;
an elongate engagement member disposed on one of the vertical column and the distal edge, the engagement member including a distal retaining head;
a receiver disposed on the other of the vertical column and the distal edge, the receiver including a head receiving aperture, wherein the receiver receives the distal retaining head therein when the door is in the closed position and wherein application of force that is at least partially transverse to the planar extent of the door causes the distal retaining head to be captured in the head receiving aperture thereby preventing the door from entering the open position.

10. The door chucking system of claim 9, further comprising:
a plastic bracket connected to the vertical column.

11. The door chucking system of claim 9, further comprising:
the elongate engagement member includes a plastic sleeve.

12. The door chucking system of claim 9, further comprising:
the head receiving aperture includes inboard and outboard sides and a head slot disposed on the outboard side of the head receiving aperture.

13. The door chucking system of claim 12, further comprising:
the head slot includes perimeter having an arc that is greater than an arc of the elongate engagement member, but less than an arc of the distal retaining head.

14. A method of securing a door in a door opening of a vehicle, comprising:
providing a vehicle door having an inboard side, an outboard side, and a distal edge, the vehicle door being movable between open and closed positions;
forming a vertical column that is proximate the distal edge of the vehicle door when the vehicle door is in the closed position;
providing a receiving member on the other of the distal edge of the vehicle door and the vertical column;
extending an engagement member from one of the distal edge of the vehicle door and the vertical column, wherein the engagement member includes a securing portion;
applying an outward force to the inboard side of the vehicle door; and
engaging the securing portion of the engagement member with the receiving member.

15. The method of claim 14, further comprising:
constructing a receiving slot in the receiving member that is interlockingly engageable with the securing portion of the engagement member.

16. The method of claim 14, further comprising:
covering at least a portion of the engagement member with a pliable material that malforms during the application of outward force to the inboard side of the vehicle door.

17. The method of claim 14, further comprising:
forming the engagement member into a wedge and forming the securing portion into retaining slot.

18. The method of claim 14, further comprising:
forming the securing portion of the engagement member into a distal retaining head.

19. The method of claim 14, further comprising:
the vehicle door is slidable in the vehicle door opening between the open and closed positions.

20. The method of claim 14, further comprising:
securing the retaining member on a retaining member base plate and the engagement member on an engagement member base plate.
